(19) United States
(12) Patent Application Publication
(10) Pub. No.: US 2017/0003663 A1
(43) Pub. Date: Jan. 5, 2017

(54) Equipment Isolation System

(71) Applicant: Remsafe Pty Ltd, BALCATTA Western Australia (AU)

(72) Inventor: Michael Charles Lane, Dianella (AU)

(21) Appl. No.: 15/199,607

(22) Filed: Jun. 30, 2016

(30) Foreign Application Priority Data
Jun. 30, 2015 (AU) 2015902559

(51) Int. Cl. G05B 9/02; B65G 43/00; H04W 88/02

(52) U.S. Cl. CPC G05B 9/02; H04W 88/02; B65G 43/00; G05B 2219/33204

(57) ABSTRACT

An equipment isolation system (10) for remotely isolating equipment (20,21) in a plant comprising equipment (20,21) energisable by an energy source (30) and a control system (50,260) for controlling operation of said equipment (20,21) and isolation of said equipment (20,21) from said energy source (30) to an isolated state by an operator, wherein said control system (50,260) includes an identification device for an operator to provide operator identification data to the control system (50,260) as a step in using the isolation system (10).

This invention relates to an equipment isolation system for remotely isolating equipment from an energy source.

Various types of equipment must be isolated from a range of energy sources including electrical energy (the most common) and mechanical energy including pressure and potential energy to enable safe maintenance and other work to be carried out. Conveyor belt systems used in the mining industry for transporting iron ore or other bulk materials which can span significant distances are one such example of equipment which may require to be isolated from time to time.

The distances such conveyors can span can be in the range of many kilometres. Such conveyors are typically powered by electric drive motors: three phase electrical power is supplied wherein the voltage may range from low voltage ranges (from below 600V to 1000V AC), to medium and high voltage ranges (in the multiple kV range and extending to above 10 kV AC and even 33 kV AC). Such conveyors typically include brake systems which are also electrically operated.

Although different mine procedures and relevant safety standards may apply, a typical pre-requisite before permitting mechanical maintenance or other activity involving access to the conveyor belt system involves the electrical isolation of the conveyor belt system. This isolation ensures that the energy source powering the conveyor belts and associated equipment, i.e. electrical power, is removed from systems that—if energised—could cause a safety hazard. It will, however, be understood that equipment items other than conveyor systems also require isolation for maintenance and other purposes.

The isolation process is invariably safety critical and has, in the past, been time consuming, as described for example in the introduction to the Applicant's granted Australian Patent No. 2010310881 and International Publication No. WO 2012/142674, the contents of which are incorporated herein by way of reference.

The equipment isolation system described in Australian Patent No. 2010310881 enables equipment isolation to be requested at a remote isolation station associated with the equipment and subsequently approved through a plant control system, without mandatory visitation to the equipment by authorised isolation personnel. This equipment isolation system significantly reduces time for achieving safe isolation, especially production downtime which can be very costly.

Equipment isolation in an industrial plant, being safety critical, is typically the subject of detailed procedures. Such procedures are necessary because of the innately hazardous nature of much plant equipment as well as its complexity. Such detailed procedures usually contain rules on the following subjects:
personnel authorised to isolate particular equipment (noting that a group of people may need to be involved in an isolation event);
permission to work in particular areas;
the order in which equipment items are to be isolated and other steps; and
the issuing of authorisations and permits.
   Safety is highly dependent on authorised personnel performing each task of an isolation procedure correctly. It is essential to avoid unauthorised personnel performing any task during the isolation procedure. The Applicant has found that such unauthorised activity is, though generally small in scale, nevertheless potentially very hazardous.

The present invention has an object of addressing use of an isolation system by unauthorised personnel.

With this object in view, the present invention provides an equipment isolation system for remotely isolating equipment in a plant comprising:

equipment energisable by an energy source; and

a control system for controlling operation of said equipment and isolation of said equipment from said energy source to an isolated state by an operator,

wherein said control system includes an identification device for an operator to provide operator identification data to the control system as a step in using the isolation system.

The control system conveniently includes a processor for reading and comparing said operator identification data with identification data stored in a storage devices, such as an electronic database forming part of the control system which may extend to the plant control system, for operators authorised to use the equipment isolation system. The control system is thus configured to enable use of the equipment isolation system by said operator only where the processor matches operator identification data provided to the identification device and said stored identification data. This allows verification of the operator's identity and authority to use the isolation system and can be understood as a pre-approval for isolation to be requested and effected by a particular operator.

The identification device may take a number of possible forms. The identification device could, for example, be:
a keypad for inserting personal identification information (numeric, alpha-numeric or otherwise) for an operator;
a card reader which reads operator identification data stored, for example, on contact or contactless smart cards; and/or
a biometric device which may include a camera and processor for operator facial, iris or retinal recognition, or a finger print pad and processor for operator fingerprint identification.

Operator identification data may, as alluded to above, be provided directly to the operator identification device or by bringing an operator identification means into communication with the operator identification device. Operator identification means may comprise a range of devices including smart devices such as smart cards and smart phones. Other devices for communicating operator identification data to the operator identification device may be used. All such devices may also function as a plant access means required for an operator to access a plant or work area.

A combination of identification devices and operator identification means could be used to assure higher security for the equipment isolation system. For example, an operator may be required to successfully pass a card scan and input both personal identification information and/or supply biometric data before accessing and using the equipment isolation system.

Operator identification data may be stored in the control system following a conventional process and such data could include, or be tied to, isolation permits to work on relevant equipment as described in the Applicants Australian Provisional Patent Application No. 2015902564 filed on 30 Jun. 2015, the contents of which are incorporated herein by way of reference. This option reduces risk of error in issuing isolation permits through manual documentation systems which can also be time consuming to use and check. Such benefits can contribute to increasing safety and reducing lost production time for maintenance purposes.

If an operator fails to demonstrate requisite authority, for example by inputting incorrect or unauthorised identification data to the identification device, the equipment isolation system may sense and flag this by issuing an alert signal and enabling an opportunity for correction and issuing a further alert signal, for example to control room and plant security, if no correction is made. Situations may arise where an operator, once authorised, has that authority withdrawn. Such situations may be handled in the same manner as if unauthorised identification data had been input to the identification device.

Smart devices may be configured and programmed with operator identification data using a conventional programming process, preferably in a pre-configuration step prior to an isolation process. Smart devices may conveniently be provided with other functionality and may also include appropriate communications equipment to store and transmit plant and other relevant data (including operator tracking (e.g. by GPS), reports, alarms and so on). Interfacing with the plant control system including its messaging systems (by text, voice message or otherwise) is also possible. Where smart cards, conveniently standard production smart cards, are used, operator identification data is stored in smart card memory and also in a memory of the control system conveniently in the form of the operator database described above.

The control system typically includes, or interfaces with, a plant control system which, when provided with operator identification data such as the above described isolation permits, may check and confirm an operator authority including an operator authority selected from the group consisting of an operator is authorised to effect an isolation for the equipment, an operator has the correct isolation permit(s) and an operator has authority to access or depart from a work area or plant site.

The equipment isolation system may advantageously include the Applicant's remote isolation systems with a control system that authorises isolation on permissible request logged by an operator at a remote equipment isolation station. One or a plurality of such remote isolation stations for selected equipment to be isolated may be provided. Such remote isolation stations are in communication with the control system to enable isolation on permissible request and are provided with control panels having input means, such as a human machine interface, for logging the operator request. Such remote isolation stations, and conveniently the human machine interface, would include the identification device described above so that the operator must demonstrate authority through appropriate identification data input to the identification device before proceeding further to actually use the equipment isolation system. Remote isolation stations may be fixed or mobile or a combination of the two types.

Isolation systems typically include an equipment isolation switch for use in isolating equipment, the switch being movable between a first position in which said equipment item is energised by an energy source and a second isolated position in which the equipment is isolated from the energy source. The switch must be locked to complete isolation or unlocked during de-isolation, a personal padlock (whether alone or affixed to a hasp which is connected to the switch) currently being used for the purpose. A number of personal locks may be applied by different operators involved in an isolation process. For example, an equipment isolation switch may be configured with an electro-mechanical lock operable only where each concerned operator (as a plurality of operators may also work on or during an isolation process) has input authorised identification data to the identification device, for example using a card reader, keypad or both, as described above. Such an electro-mechanical lock may also obviate need for a padlock or hasp for locking out and, in doing so, increase safety by minimising unauthorised operation of such devices which currently can occur on occasion. To that end, there is also provided an equipment isolation system for remotely isolating an equipment item comprising:

an equipment isolation switch movable between a first position in which said equipment item is energised by an energy source and a second isolated position in which said equipment item is isolated from said energy source; and

an actuating device co-operable with the equipment isolation switch to move it between said first and second positions; and

an operator identification device for identifying an operator authorised to operate the equipment isolation switch wherein said actuating device is an operator identification means which also allows locking out and unlocking of the equipment isolation switch when communicated with the operator identification device.

The control system can control, and record details of, the operator(s) equipment isolation switch operation, for example locking out using operator identification means, such as smart cards, including name, date and time. A similar procedure would be followed on de-isolation. De-isolation may again require the concerned operator(s) to present valid identification data to the control system using the identification device as a pre-condition to de-isolation.

The remote isolation system may include features to prevent an operator leaving equipment in an isolated state by mistake. For example, an operator who has isolated some equipment and locked out, for example using a personal lock, may leave the equipment area or even the site without removing their personal lock. This may cause significant problems and consequences for both operator and plant owner. To this end, the control system may monitor operator activity, for example by tracking the operator identification means, and trigger an alert if it detects and flags that an operator has failed to de-isolate equipment when safe to do so. One alert condition could be an attempt by an operator to depart from the work area or plant site without having de-isolated equipment when safe to do so

This may also be addressed by making operator departure from a particular area or site conditional on presenting operator identification means to an operator identification device located at any access means to the work area or plant site which, on communicating with the control system, may alert the operator that removal of the personal lock is required. Access means to the site, such as an automatically operated door or gate, may fail to operate in case of such an alert.

The equipment remote isolation system may be retro-fitted to existing equipment and plant in a range of industries, for example the materials handling and mining industries. The remote isolation system may also advantageously be used for isolating rail system components in railway infrastructure.

The term “isolation” as used in this specification is to be understood in its maintenance engineering and legal sense as not simply turning off a supply of energy to equipment, whatever the nature of that energy, but removing and/or dissipating energy to provide a safe work environment as required by applicable occupational health and safety regulations. In the case of electricity, as just one example, isolation is not achieved simply by turning off a power supply to the equipment. In such cases, the equipment could accidentally re-start or be restarted and cause injury to personnel, or worse. Isolation instead prevents such accidental re-starting and typically will also involve processes to dissipate any hazardous stored energy, in whatever form that energy may take (e.g. potential energy), from the equipment. For example, such an additional energy dissipation step could be effected in respect of a conveyor belt system by way of the braking cycle procedure as described in the Applicant's Australian Provisional Patent Application No. 2015902565, the contents of which are incorporated herein by way of reference. The remote equipment isolation system of the present invention may be more fully understood from the following description of preferred embodiments made with reference to the following drawings in which:

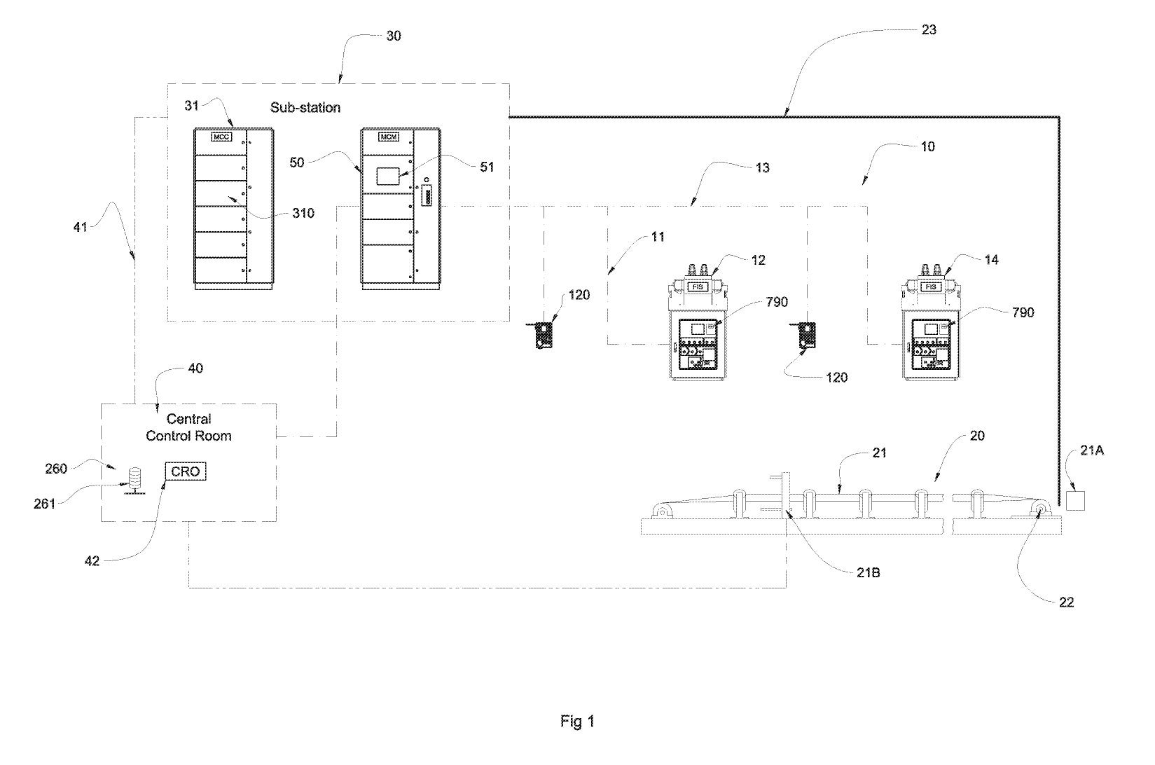

FIG. 1 shows a schematic layout of an equipment isolation system as applied to a conveyor belt system and configured in accordance with one embodiment of the present invention.

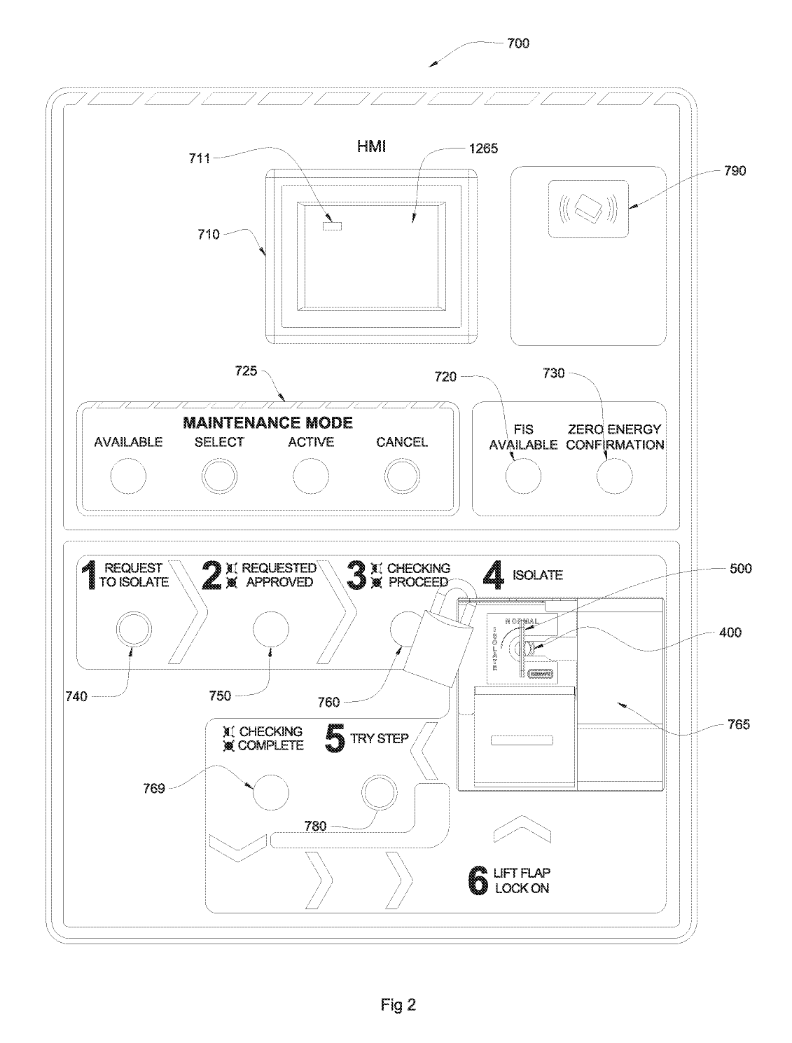

FIG. 2 shows a schematic of a control panel for a fixed equipment isolation station used in the equipment isolation system schematised in FIG. 1.

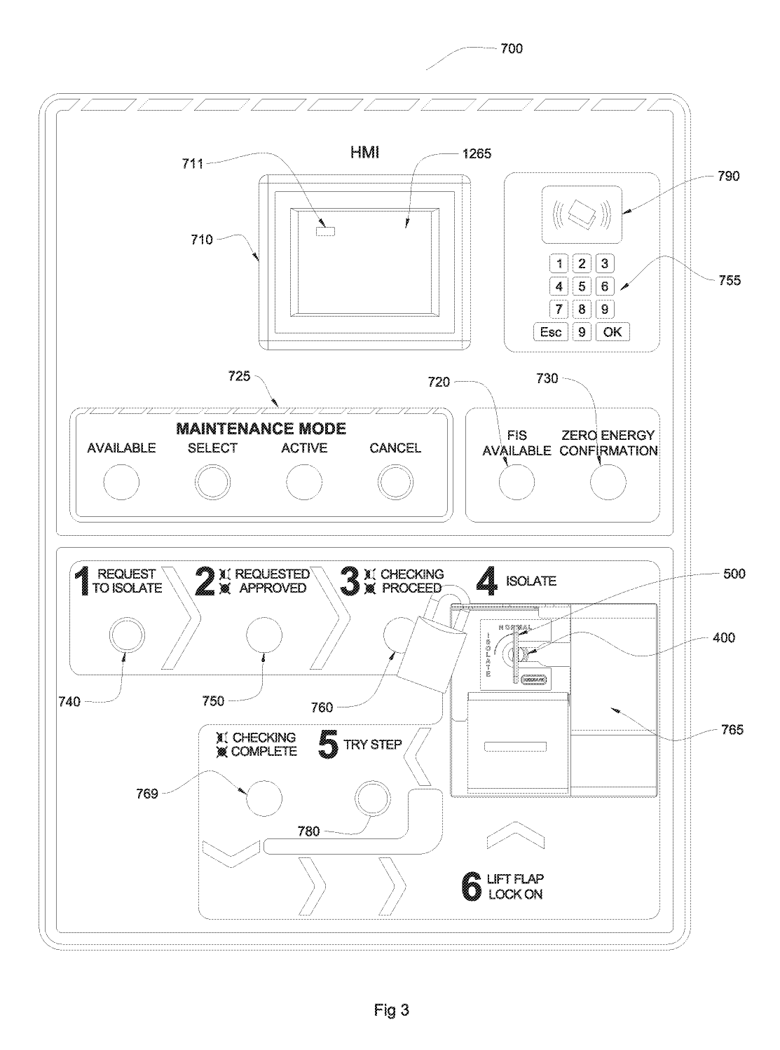

FIG. 3 shows a schematic of a further embodiment of control panel for a fixed equipment isolation station useful for the equipment isolation system schematised in FIG. 1.

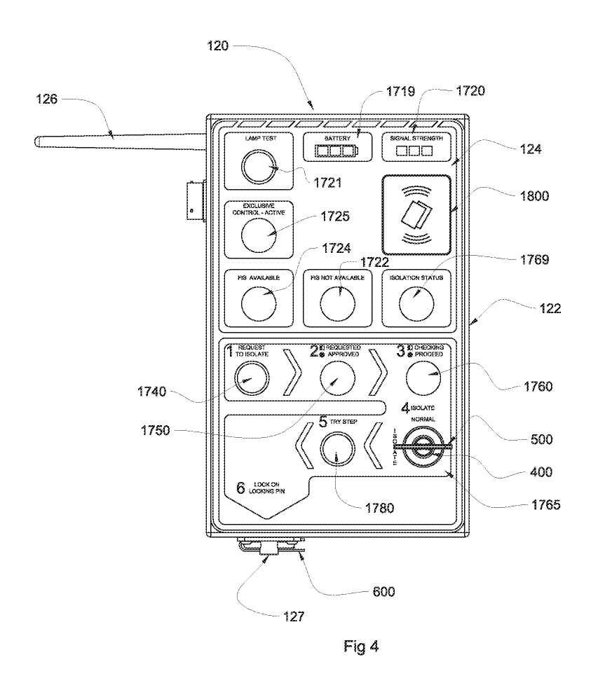

FIG. 4 shows a front view of a mobile isolation device for use in the equipment isolation system schematised in FIG. 1, the mobile isolation device being in isolated condition.

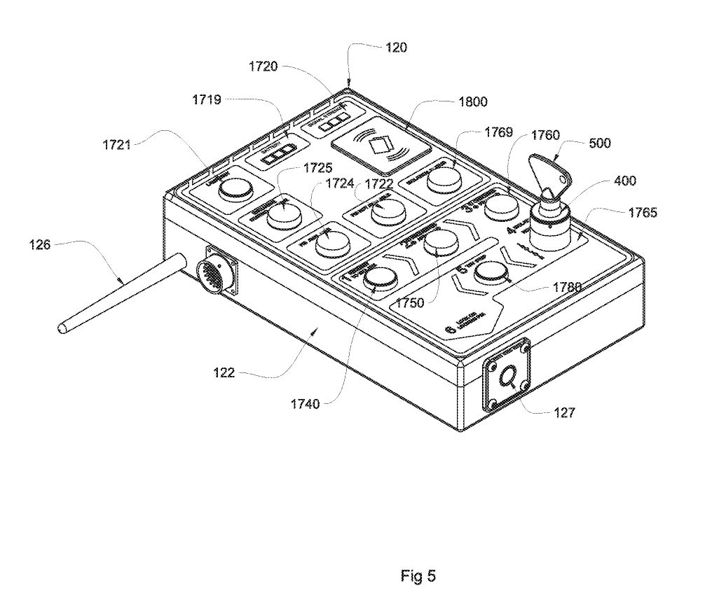

FIG. 5 shows a first side perspective view of the mobile isolation device of FIG. 4 in normal or “resting” position.

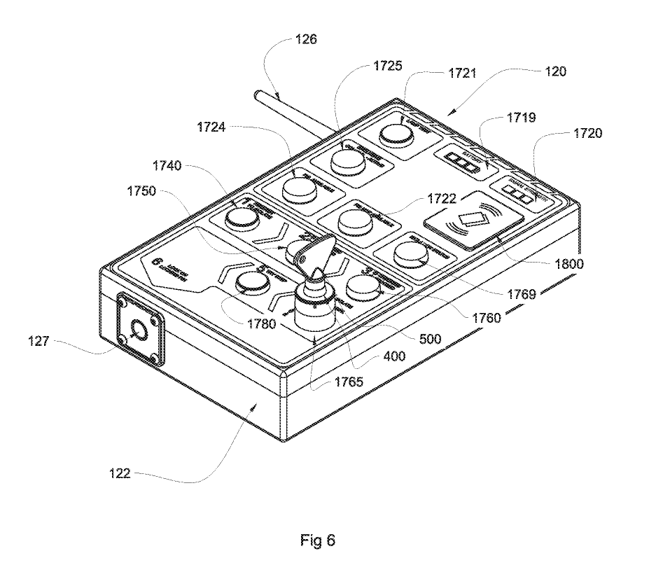

FIG. 6 shows a second side perspective view of the mobile isolation device of FIGS. 4 and 5.

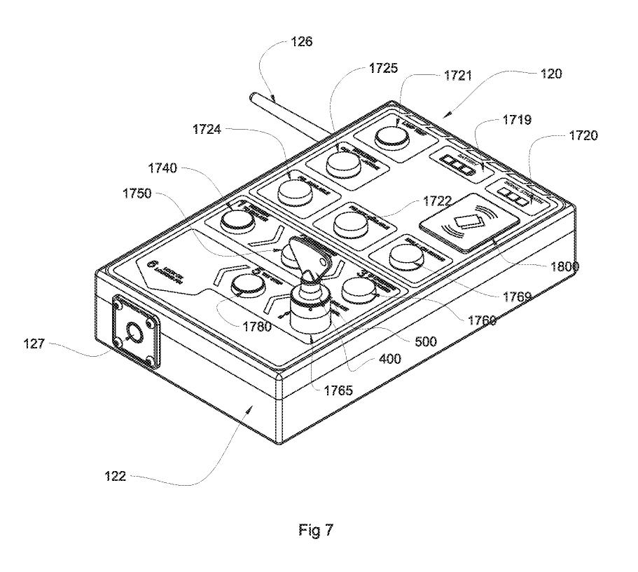

FIG. 7 shows a side perspective view of the mobile isolation device of FIGS. 4 to 6 with isolation switch turned to the ISOLATE position prior to lockout.

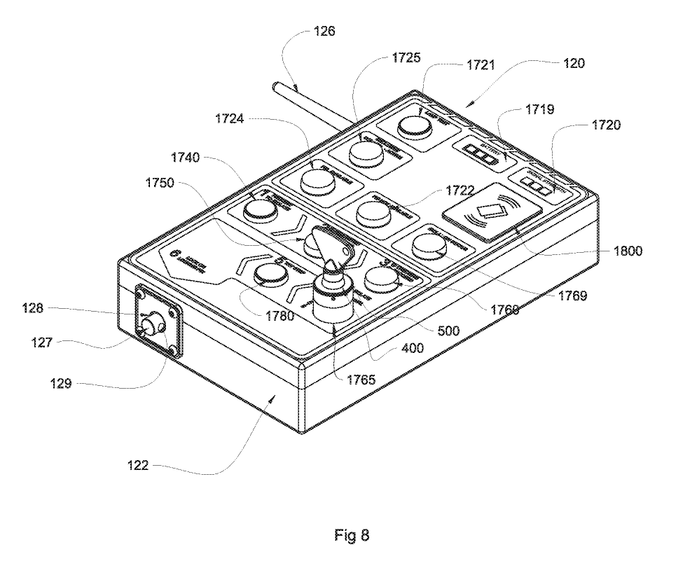

FIG. 8 shows a side perspective view of the mobile isolation device of FIGS. 4 to 7 with isolation lockout point provided on completion of an isolation procedure.

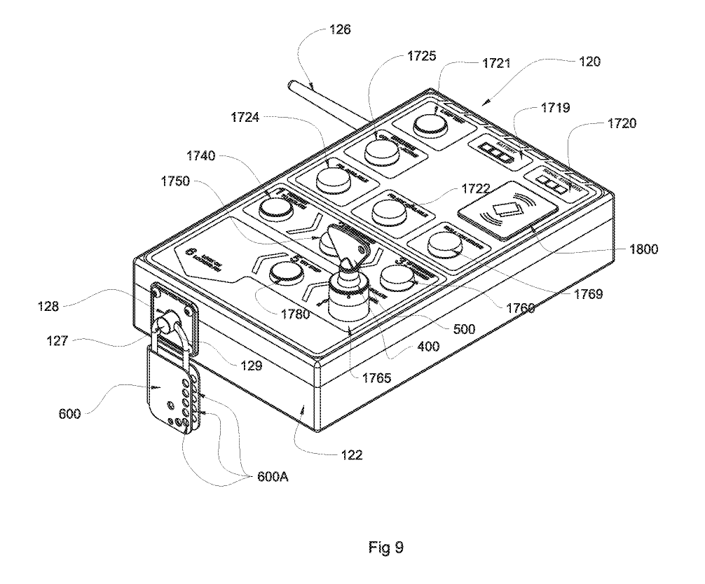

FIG. 9 shows a side perspective view of the mobile isolation device of FIGS. 4 to 8 in isolated and locked out condition.

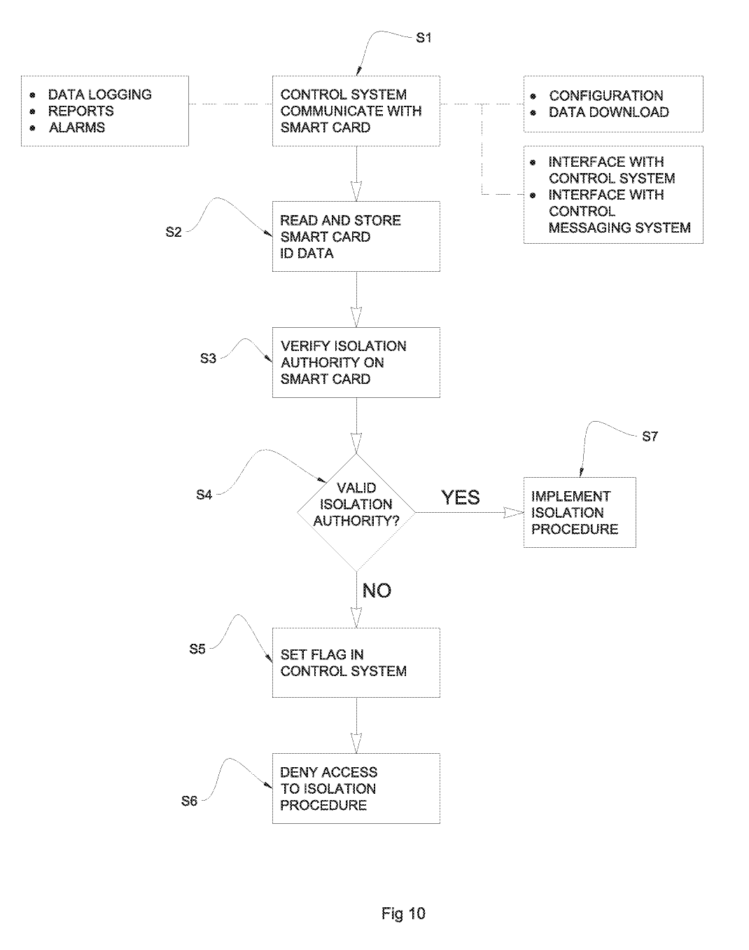

FIG. 10 shows a first logic flow diagram for operation of an equipment isolation system as schematised in FIG. 1 and using the control panel shown in FIG. 2.

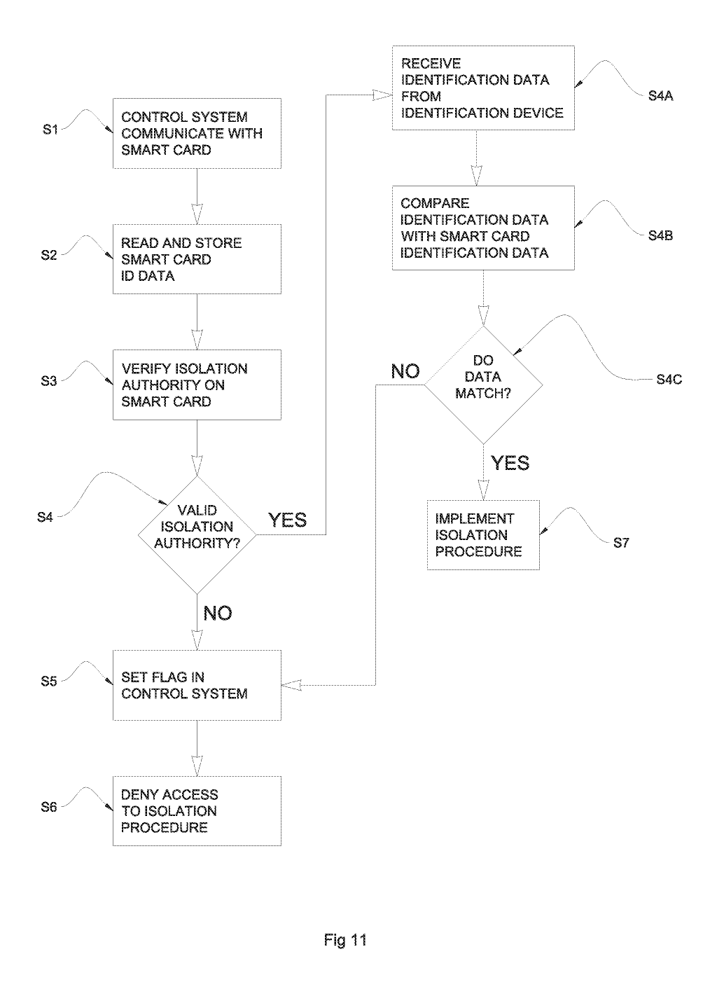

FIG. 11 shows a second logic flow diagram for operation of an equipment isolation system as schematised in FIG. 1 and using the control panel shown in FIG. 3.

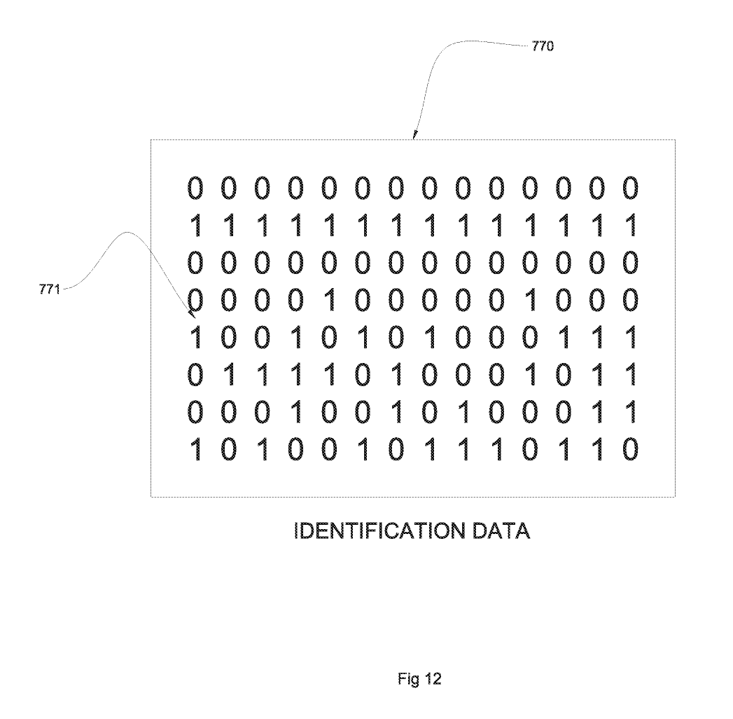

FIG. 12 shows a schematic of the memory block of a contactless smart card for use in an equipment isolation system in accordance with embodiments of the present invention.

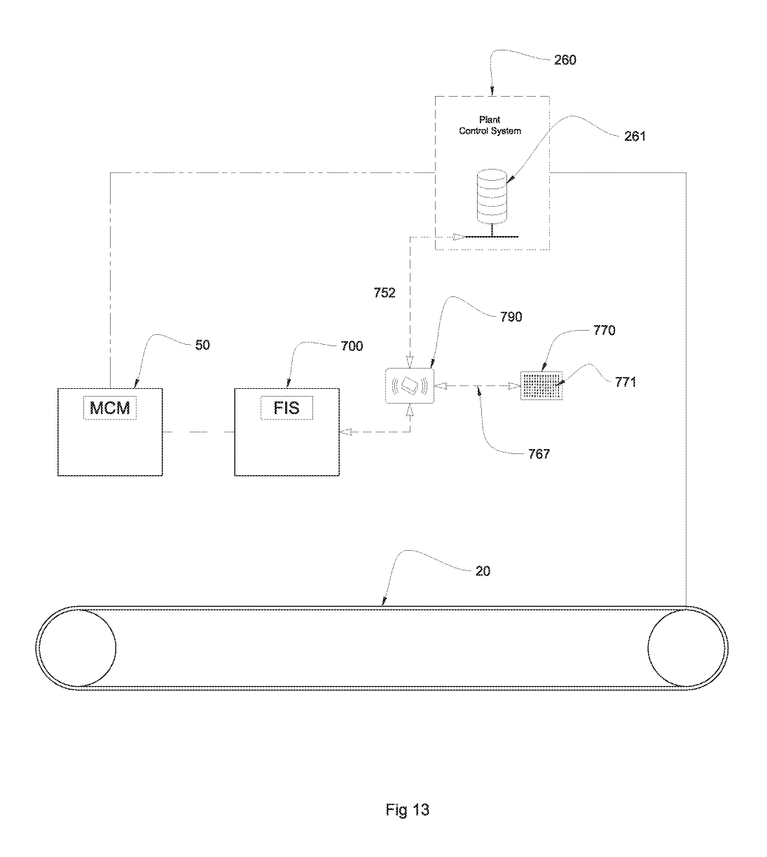

FIG. 13 shows a schematic showing the first embodiment of identification device and its relationship to other components of the equipment isolation system schematised in FIG. 1.

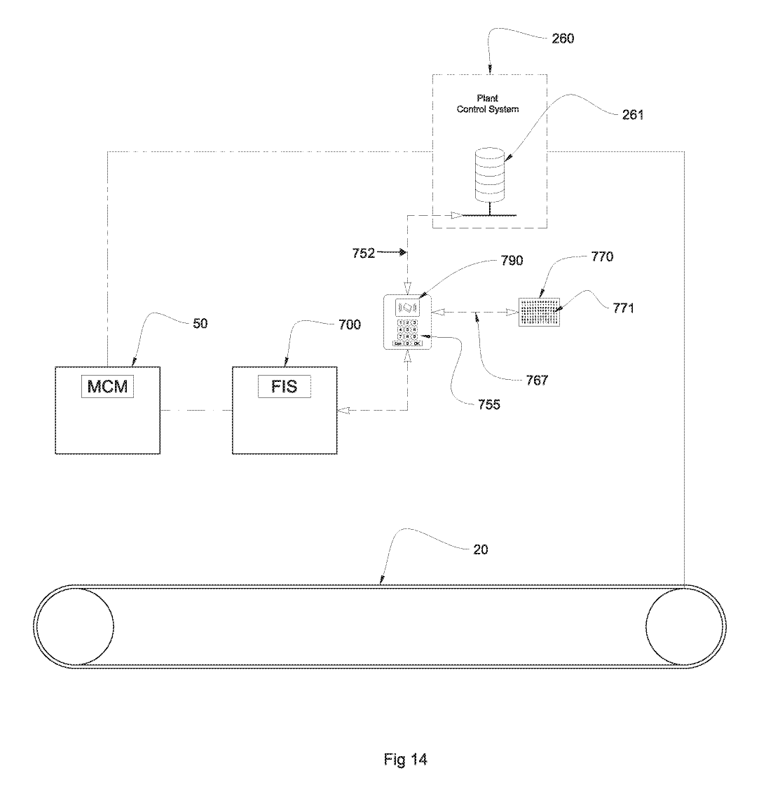

FIG. 14 shows a schematic showing the second embodiment of identification device and its relationship to other components of the equipment isolation system schematised in FIG. 1.

Referring to FIG. 1, there is shown a schematic layout of an equipment isolation system 10, as retrofitted on to an existing conveyor belt system 20, for example a long range conveyor system for conveying iron ore. The conveyor belt system 20 comprises a troughed conveyor belt 21 having a head pulley drive motor 22 driven by an electrical supply emanating from electrical contacts 31, whether provided as contactors or circuit breakers. The head pulley motor 22 is powered through a variable speed drive (VSD) which is electrically powered from a 3 phase AC power supply line 23 providing voltage of less than 1000V AC. Conveyor belt 21 is provided with electrically powered braking system 21A and a Tramp Metal Detector (TMD) 21B for detecting metallic debris if present on the conveyor belt 21.

Electrical power for conveyor belt system 20 is supplied from a sub-station 30. The sub-station 30 houses the contacts 31. Activation of the contacts 31 (i.e. placing them in the “off” or “break” state), de-energises all 3 phases of the electrical supply to the conveyor head pulley drive motor 22. Activation of contacts 310 also located within the sub-station 30 similarly de-energises all 3 phases of the electrical supply to the conveyor braking system 21A. Such de-energisation is continuously monitored by a voltage monitor relay (not shown) located downstream of contacts 31, i.e. on the conveyor belt system 20 side of the contacts 31.

The conveyor belt system 20 and sub-station 30 are under the control and supervision of a plant control system 260 having a Central Control Room (CCR) 40, via a DCS (Distributed Control System), a PLC (Programmable Logic Controller) and a SCADA (Supervisory Control and Data Acquisition System) as are commonly used and would be well understood by the skilled person. Item 41 in FIG. 1 is representative of a communication and control network between the CCR 40 and various other plant systems and components. A Control Room Operator (CRO) 42 is located within the CCR 40 and has various Input/Output (I/O) devices and displays available (not shown) for the proper supervision and control of the conveyor belt system 20. Except for the equipment isolation system 10, the above description represents what may be considered a conventional system in the materials handling and mining industries.

The equipment isolation system 10 comprises fixed position equipment isolation stations 12 and 14 which are located proximate to the conveyor belt system 20. Equipment isolation stations 12 and 14 could be replaced or supplemented by one or more mobile isolation devices 120, one form of which is described in further detail below. Mobile isolation devices are also disclosed in the Applicants Australian Provisional Patent Application Nos. 2015902561 and 2015902562 filed on 30 Jun. 2015, the contents of which are incorporated herein by way of reference. The equipment isolation stations 12 and 14 may be powered from the plant grid, other power networks or alternative power sources, conveniently such as solar power.

Mobile isolation stations 120, unlike fixed equipment isolation stations 12 and 14, can be used anywhere around conveyor belt system 20 providing significant flexibility and reducing the need to spend time travelling to and fro between fixed equipment isolation stations 12 and 14 for communications tasks and maintenance tasks in a work area of the conveyor belt system 20. This should reduce downtime and increase productivity without compromising safety. It will be understood that equipment isolation system 10 could altogether dispense with fixed equipment isolation stations in favour of mobile isolation devices 120.

The equipment isolation system 10 also includes a master controller 50 incorporating a Human/Machine Interface (HMI) in the form of a touch sensitive screen 51 which displays human interpretable information. The master controller 50 is also located within sub-station 30.

Equipment isolation stations 12 and 14 and mobile isolation devices 120 communicate with master controller 50 and each other via wireless communication channels 11 and 13 respectively. The communication channels 11 and 13 form part of a wireless communications network for controlling the conveyor belt system 20 therefore saving costs and difficulty involved with installing fibre optic or other cable as described above.

The wireless communications network used in the control of conveyor belt system 20 requires a communication protocol to work effectively. This communication protocol is selected for ready interoperability with other plant components making maintenance and trouble shooting requirements easier.

That is, the communication protocol is open, not closed, enabling flexible updating on site. Plant personnel are not precluded from refining the communication protocol or left susceptible to system failures that only a third party to the plant operator/owner can address.

In this case, the communication protocol involves an industrial communication protocol. Communications relating to remote isolation must be via safety rated communications protocol software such as Interbus Safety or PROFIsafe which are Safety Integrity Level (SIL) rated and well known software within the mining and materials handling industries. This will ensure that the communication channels are monitored and diagnostic tools are available for fault control and rectification when required.

Further description of the electrical layout and operation of the equipment isolation system 10 is provided in Australian Patent No. 2010310881, the contents of which are herein incorporated by way of reference. Advantageously, the remote isolation system 10 includes securing means for continuously monitoring and maintaining isolation integrity as described in the Applicant's Australian Provisional Application No. 2015902556 filed 30 Jun. 2015, the contents of which are incorporated herein by way of reference.

FIG. 2 shows a schematic of a control panel 700 arranged as part of each of equipment isolation stations 12 and 14 for implementing the Applicant's equipment isolation system 10. Further detail of each equipment isolation station 12 and 14 is provided below. Control panel 700 has a Human Machine Interface (HMI) 710 with a touch screen 1265 (though less fragile buttons, switches and other input devices may be used in alternative arrangements) for entering commands (including isolation demand inputs in the form of operator initiated isolation requests). Information about such isolation requests including isolation status and plant data can also be presented on touch screen 1265.

HMI 710 enables the operator to request isolation of equipment within conveyor belt system 20 following verification of operator authority to isolate using a smart card reader 790 incorporated in control panel 700. Smart card reader 790 is of conventional form with an RF modem, powered by low voltage electricity supply, for communicating with smart cards 770 (as will be described further hereinafter).

Operators are provided with smart cards 770 with stored identification data appropriate to their duties. This information may also be stored on the control system that is identified with the smart card 770. This identification data is issued by control system 260 and stored in operator database 261 with a record for each operator on site. Such identification data is also stored in memory blocks 771 of the smart card 770 as schematically shown in FIG. 12 using a conventional smart card programming process. The programming progress may issue different operators with unique identification data which may act as an access card allowing the operator access to the site; and then both as authority to access the equipment isolation system and isolation permit to work on specific tasks on the conveyor belt system 20 or be present within an area of works on the conveyor belt system.

As schematically shown in FIGS. 10 and 13, at step S1 control system 260, through smart card reader 790, communicates wirelessly (at radio frequency along communication line 767) with the operator's contactless smart card 770. Although isolation is the focus for such communication in the flowchart, smart cards 770 may be interfaced with smart card reader 790 and control system 260 for other purposes, for example to configure them, download data to them, retrieve logging data from them, interface with other plant components and so on. Smart cards 770 may, through use of appropriate communications equipment included in the smart card system, store and transmit plant and other relevant data (including operator tracking, reports, alarms and so on). Interface with plant control system 260 including its messaging systems (by text, voice message or otherwise) is also possible. This functionality is indicated in FIG. 10.

At step S2, smart card reader reads its stored identification data from memory blocks 771. The identification data is recorded and sent, at step S3, to plant control system 260 for verification through comparison, at step S4, with stored isolation authorities data in operator database 261 to isolate conveyor belt system 20. Operator name, date and time of attempted access are recorded in operator database 261.

Even if smart card 770 is validated, plant control system 260 performs a check to authorise a permit to isolate conveyor belt system 20.

In either case, if the operator's input and stored identification data do not match showing a lack of validity of smart card 770 or a lack of authorisation through isolation permit, the control system 260 flags this situation at either step S5 or step S6 and issues an alarm to the CRO 42 for appropriate response. At step S6, the operator is denied access to the isolation procedure through the control panel 700 and an alarm is generated at CCR 40.

Further security can be achieved by using a control panel 700 (as shown in FIG. 3) including an additional identification device 755 taking the form of a keypad as schematically shown by FIGS. 3 and 14. In such case, an operator seeking to isolate conveyor belt system 20 brings smart card 770 into communication with smart card reader 790 which confirms that the smart card 770 is valid at steps S1 to S4 as previously described. If not, the operator can take no further isolation action at control panel 700 and this situation may be flagged on touch screen 1265 and at the CCR 40 for the CRO 42 to take appropriate response action in steps S5 and S6 as described above. If the operator's smart card 770 is valid, the operator must still input identification data (a personal identification code) to keypad 755 before proceeding further to use equipment isolation system 10. As will be evident from FIGS. 11 and 14, a corresponding signal is wirelessly sent through communication line 752 to plant control system 260 which receives the identification data signal at step S4A for verification and processing, through comparison with stored isolation authorities on operator database 261 at steps S4B and S4C. If the input and stored identification data do not match, the control system 260 flags this situation at step S5 and issues an alarm to the CRO 42 for appropriate response. At step S6, the operator is denied access to the isolation system through the control panel 700.

If the input and stored operator identification data successfully match, the operator may proceed to implement the isolation procedure for the conveyor belt system 20 at step S7. To that end, control panel 700 also includes:
Indicator light 720 showing whether or not the equipment remote isolation station (RIS) 12 or 14 is available for isolation;
Indicator light block 725 showing whether or not exclusive or maintenance mode for the remote isolation system is available or active as described in Australian Provisional Patent Application No. 2015902557 the contents of which are incorporated herein by way of reference; and respective “select” and “cancel” buttons for initiating or terminating the maintenance mode;
Indicator light 730 to provide zero energy confirmation when sensors, such as at least the load voltage monitor relay described above for contacts 31 and preferably conveyor belt 21 movement sensors as well, indicate zero hazardous energy in the conveyor belt system 20 (i.e. a zero energy indication is achieved when the culmination of all energy sources being monitored confirms that there is no stored or latent energy (whether potential, or electrical etc) remaining in the system desired to be isolated);
Request to isolate button 740 which is activated by an operator (and which illuminates when pressed) to request isolation and “request approved” indicator light 750 which illuminates to provide status information to said operator. Button 740 also illuminates when pressed;
Indicator light 760 for indicating that control system checking is taking place subsequent to an isolation request being instigated;
Indicator light 769 for showing whether or not the isolation is complete following control system checking; and
Graphics in the form of arrows and text) illustrating the sequence of steps to be followed in the required isolation procedure.

Control panel 700 includes an equipment isolation switch 765 which prevents completion of the isolation process by locking with an operator's padlock (whether alone or when affixed to a hasp) until the correct equipment isolation procedure, for example as described in the Applicant's granted Australian Patent No. 2010310881 or Australian Provisional Patent Application No. 2015902554, has been completed.

If the operator demonstrates authority to isolate conveyor belt system 20 with the use of the smart card system as above described, the conveyor belt system 20 is isolated by a procedure involving the following sequence of steps:
1) Operator request by pressing button 711 on screen 1265 of HMI 710 of equipment isolation station 12 for plant control system 260 to approve isolation of all or part of conveyor belt system 20 including conveyor belt 21 and head pulley drive motor 22;
2) Isolation approved if operator request meets permissives for isolation, for example as described in granted Australian Patent No. 2010310881;
3) Isolation automatically implemented by the plant control system 260;
4) Try start step being invoked to check that the isolation is effective, which involves checking that electrical contacts 31 for the conveyor belt system 20 are in isolated position with no voltage downstream of electrical contacts 31 as continuously monitored by the above described voltage monitor relay (and desirably conveyor belt 21 movement sensors as well); an attempt to re-start the conveyor belt system 20 using a try step button 780 or an automated process; and checking that there is no re-energisation of conveyor belt system 20 (which may involve monitoring as described in the Applicant's Australian Provisional Patent Application No. 2015902556, the contents of which are incorporated herein by way of reference); and
5) Lockout at a control panel 700 of equipment isolation station 12 and/or 14 if the try start is unsuccessful (as required).

In particular, a correct equipment isolation process requires a try start step to be completed by an operator by activation of a try step button 780 before any manual lock out is possible. The equipment isolation switch 765 is designed to prevent any such manual lock out before the correct isolation process has been completed.

Equipment isolation switch 765 includes an equipment isolation switch 400 operable by turning key 500 between a first “NORMAL” position in which the head pulley drive motor 22 for conveyor belt 21 is electrically energised (i.e. not isolated) and a second “ISOLATE” position in which the drive motor 22 is electrically isolated and thus without power facilitating any maintenance works which may be required. However, turning key 500 from the NORMAL to ISOLATE positions is a necessary but not sufficient condition for the equipment isolation system to properly isolate conveyor belt 21 and its drive motor 22. The isolation switch 400 must be locked out. This has been done to date, as described above, by a manual lock out procedure using a personal lock in the form of a padlock.

It will be understood that other isolation switch equipment could be used. An alternative isolation switch assembly, including a securing means to maintain key 500 in co-operation with isolation switch 400 as described in the Applicant's Australian Provisional Patent Application No. 2015902554, the contents of which are incorporated herein by way of reference could also be used.

In an alternative embodiment, using the same control panel 700, the hasp for locking out isolation switch 400 would be substituted by an electro-mechanical lock operable (through lock out or lock off) on presentation of a valid smart card(s) 770 to smart card reader 790 during the isolation procedure. This minimises risk of misuse of the prior mechanical locks which has occasionally been an issue.

Referring now to FIGS. 4 to 9, one or more mobile isolation device(s) 120, rather than a fixed equipment isolation station, may be used for accessing the equipment isolation system. Such mobile isolation device 120 is similar to that described in the Applicant's Australian Provisional Patent Application No. 2015902562 and has advantages of portability and flexibility to handle a number of isolation scenarios in a number of plant settings.

It should be noted that for certain specific applications, the mobile isolation device could take the form of a re-configured smart phone or other smart device in which telephonic function (or Voice Over Internal Protocol (VOIP)) is integrated for communications with the CRO 42. Control panel 124 is used for implementing the Applicants remote isolation system 10 and includes an antenna 126 for implementing wireless communications, in the above described manner, with plant control system 260 and master controller 50. Wireless communications are line of sight with additional repeaters used if necessary to maintain satisfactory communications integrity. Plant transport vehicles may also include such repeaters.

Mobile device 120 is powered by a rechargeable battery (not shown). The mobile isolation device 120 is manually portable having dimensions (provided as an example only) of 230 mm×370 mm.

As can be seen in FIG. 4, the control panel 124 includes:
Battery storage indicator light block 1719;
Wireless signal strength indicator light block 1720;
Lamp test request button 1721;
Indicator lights 1722 and 1724 showing whether or not the mobile isolation device 120 is available for isolation;
Exclusive control selection button 1725 for selecting exclusive control and illuminable to indicate whether or not exclusive control is active (exclusive control where conveyor belt system 20 isolation is controlled exclusively from mobile isolation device 120 is described below);
Request to isolate button 1740 which is activated by an operator (and which illuminates when pressed) to request isolation;
Request approved indicator light 1750 which illuminates to provide status information to said operator;
Indicator light 1760 for indicating checking of the isolation procedure;
Indicator light block 1769 for showing whether or not the isolation process is complete following control system checking;
Try step button 1780 for requesting a try step in which a restart of conveyor belt system 20 is attempted (and which illuminates when pressed); and
Graphics (in the form of arrows and text) illustrating the sequence of steps to be followed in the required isolation procedure.

Mobile isolation device 120 also enables the operator to request isolation of equipment within conveyor belt system 20 following verification of operator authority to isolate using a smart card reader 1800 incorporated in control panel 124. This smart card reader 1800 operates in the same way as smart card reader 790 described above and the operator follows the same procedure to isolate as schematised in FIGS. 10 and 13, control panel 700 being replaced with control panel 124 and smart card reader 790 being replaced with smart card reader 1800.

It will be understood that the mobile isolation device 120 could be provided with a touch screen for issuing commands and providing plant status information. Any such touch screen for the mobile device 120 could conveniently be provided as a low power consumption LCD screen. However, where the isolation device is likely to be subjected to demanding service where wear and damage is almost inevitable, the touch screen may be omitted.

Mobile isolation device 120 may also be provided with alarms in the form of an audible alarm and/or alarm lights as required.

Control panel 124 also includes an equipment isolation switch block 1765 and isolation switch 400, as described above for control panel 700, which prevents completion of the isolation process (i.e by locking with an operator's padlock or hasp at a specific lockout point) until the correct remote isolation request procedure, for example as described in Australian Patent No. 2010310881 has been completed. In particular, a correct remote isolation request procedure requires a try start step to be completed by an operator by activation of try step button 1780 before any manual lockout is possible.

Equipment isolation switch 400 co-operates with a switch actuating device in the form of key 500 whenever remote isolation system 10 is operative, i.e available to achieve remote isolation. Equipment isolation switch 400 is again operable by turning the key 500 between a first “NORMAL” position in which the drive motor 22 for the conveyor 21 is electrically energised (i.e. not isolated) and a second “ISOLATE” position in which the drive motor 22 is electrically isolated and thus without power thereby facilitating any maintenance works which may be required. This condition is shown in FIG. 7.

If the correct remote isolation procedure has been followed, mobile isolation device 120 provides a lockout point 128 for the operator to apply a hasp and personal lock 600. The isolation lockout point is provided by an electrically driven extension of sliding retractable pin 128 normally located within and so concealed (though protected) by a socket of mobile isolation device console 122 at the conclusion of the isolation procedure as shown in FIG. 8. A small electric motor (not shown) is provided for this purpose. The isolation lockout point is formed by an aperture 129 extending through a diameter of pin 128 and hasp 600 may readily be applied to this lockout point as shown in FIGS. 4 and 9. Other operators may also need to apply personal locks and apertures 600A allow for this. Lockout by an operator at the lockout point provided by pin 128 ensures the equipment isolation switch 400 is unable to be returned to a NORMAL condition without certain pre-defined steps as prescribed for the isolation process being followed.

Again, and similarly as described with reference to control panel 700, in an alternative embodiment, using the same control panel 124, the hasp 600 for locking out isolation switch 400 would be substituted by an electro-mechanical lock operable (through lock out or lock off) on presentation of valid smart card(s) 770 to smart card reader 1800 during the isolation procedure. This minimises risk of misuse of the prior mechanical locks which has occasionally been an issue.

The equipment isolation switch 400 is only operable when the key 500 is engaged with it. Equally, the key 500 must be removed from the isolation switch 400 when deactivation of the equipment isolation switch 400 is required. Control system or authorised personnel approval would be required prior to any such removal which, even then, is only permitted when the isolation switch 400 is in the NORMAL condition. Importantly, key removal is not permitted without additional validation steps if the key switch 400 is in the ISOLATE condition. Deactivation would typically require other tasks to be completed before a remote isolation system is safely and completely removed from service and the equipment item in question can be re-energised for normal operation. Completion of such tasks may involve the use of other keys, preferably rendered operable using the key exchange unit described in the Applicants Australian Provisional Patent Application No. 2015902557, the contents of which are incorporated herein by way of reference.

It will be understood that communications between the mobile isolation device 120 and the plant control system 260 are sent through the wireless communications network and antenna 126 to mobile isolation device 120. Hence the operator request is sent wirelessly, as is the control system approval.

In an alternative embodiment, mobile isolation device 120 could omit a card reader in preference for a keypad for inputting a Personal Identification Code (PIC) and/or a biometric identification device in the form of a fingerprint pad and processor of conventional form. Operator identity would then be verified by comparing both the operator's PIC as keyed into the keypad and fingerprint with PICs for personnel authorised to isolate conveyor belt system 20 as stored in operator database 261 of plant control system 260. To that end, the operator's fingerprint data would be wirelessly sent to plant control system 260 for processing and comparison. If input and stored fingerprint data match, the operator would proceed to log an isolation request and the isolation procedure proceeds, essentially as described above, using the mobile isolation device 120. If not, the plant control system 260 would flag this situation and issue an alarm to the CRO 42 for appropriate response. The operator would also be denied access to the isolation procedure through mobile isolation device 120. The logic flow is very similar to that previously described with respect to FIG. 11.

Isolation permits to work at various locations around the plant and to use isolation system components such as control panel 700 and mobile isolation device 120 may be tied, as described in more detail in the Applicants Australian Provisional Patent Application No. 2015902564 which is incorporated herein by way of reference, to operator identification data as described above. If a smart card access system is used, smart card validity can be checked in the field. This option reduces risk of accidental or deliberate misuse of the remote isolation system 700 as well as risk of error in issuing isolation permits through manual documentation systems which can also be time consuming to use and check. Such benefits further help increase safety and reduce lost production for maintenance.

By way of the present invention, a smart card or smart device is able to be used with the isolation system to lock on or lock off in respect of an isolation event instead of relying on the application of a physical lock. This then has the additional benefit of enabling an added layer of security to be realised by having a requirement for a PIN or some other form of identification to be provided when an operator uses a smart card or smart device at a corresponding reader associated with the isolation system. In this way, the system requires a type of ‘pre-approval’ before an isolation is able to be requested and effected. Furthermore, the solution according to the present invention is very effective at ensuring the removal of personal locks by operators by way of the control system monitoring or tracking the movement of said operators within the site, and particularly as they seek to leave the site, and requiring them to remove their personal locks before such movements are possible.

Modifications and variations to the remote isolation system of the present invention may be apparent to the skilled reader of this disclosure. Such modifications and variations are deemed within the scope of the present invention. For example, whilst the remote isolation system has been described with reference to a materials handling plant for a mining application, it may be used in a range of industrial and other applications including isolating rail system components in railway infrastructure as described in the Applicant's Australian Provisional Patent Application No. 2015902560, the contents of which are included herein by way of reference.

Furthermore, while the control panel 700 has primarily been described as including a human machine interface (HMI) 710 with a touch screen 1265 and a series of buttons and lights (e.g. 740, 750, 760, 770, 780 etc) to enable an operator to request an isolation event, it should be noted that the control panel 700, and specifically the touch screen 1265, may be configured to provide greater control and more information about isolation system steps to an operator (or indeed full control and all information to do with the isolation system). That is, a more ‘digitally’ based input means (or indeed a totally digital system) may be arranged for operation instead of an analogue or part analogue system as described herein to enable control of the equipment isolation system according to the present invention.

1. An equipment isolation system for remotely isolating equipment in a plant comprising:
equipment energisable by an energy source; and
a control system for controlling operation of said equipment and isolation of said equipment from said energy source to an isolated state by an operator,
wherein said control system includes an identification device for an operator to provide operator identification data to the control system as a step in using the isolation system.

2. An equipment isolation system as claimed in claim 1 wherein said control system includes a processor for reading and comparing said operator identification data with identification data stored in a storage device for operators authorised to use the equipment isolation system and enables use of the equipment isolation system by an operator only where the processor matches operator identification data provided to the identification device and said stored identification data.

3. An equipment isolation system as claimed in claim 1 wherein operator identification data is provided directly to the operator identification device or by bringing an operator identification means into communication with the operator identification device.

4. An equipment isolation system as claimed in claim 3 wherein said operator identification means includes a smart device.

5. An equipment isolation system as claimed in claim 1 wherein verified operator identification data is required to operate an equipment isolation switch at the conclusion of an isolation or de-isolation process.

6. An equipment isolation system as claimed in claim 1 wherein said operator identification data includes isolation permit data.

7. An equipment isolation process as claimed in claim 2 wherein in case of incorrect or unauthorised identification data input to the identification device, the equipment isolation system flags this by issuing an alert signal.

8. An equipment isolation system as claimed in claim 4 wherein said smart device functions as a plant access means.

9. An equipment isolation system as claimed in claim 4 wherein said smart device includes communications equipment to store and transmit plant and operator data.

10. An equipment isolation system as claimed in claim 9 wherein said control system includes a plant control system which, when provided with operator identification data, checks and confirms an operator authority including an operator authority selected from the group consisting of an operator is authorised to effect an isolation for the equipment, an operator has the correct isolation permit(s) and an operator has authority to access or depart from a work area or plant site.

11. An equipment isolation system as claimed in claim 10 wherein said control system is configured to monitor and to trigger an alert if said control system detects and flags that said operator has failed to de-isolate equipment when safe to do so.

12. An equipment isolation system as claimed in claim 11 wherein said work area or plant site has at least one access means operable by an operator identification means and said access means fails to operate if said control system flags that said operator has failed to de-isolate equipment when safe to do so.

13. An equipment isolation system as claimed in claim 1 including a remote isolation station for requesting equipment isolation, said remote isolation station including said operator identification device.

14. An equipment isolation system as claimed in claim 13 wherein said control system authorises isolation on permissible request logged by an operator at said remote isolation station.

15. An equipment isolation system as claimed in claim 13 wherein said remote isolation station is mobile.

16. An equipment isolation system as claimed in claim 13 wherein said remote isolation station includes an equipment isolation switch for use in isolating equipment, said switch being movable between a first energised or de-isolated position in which said equipment item is energised by an energy source and a second isolated position in which the equipment is isolated from the energy source only where an operator has input authorised identification data to said operator identification device.

17. An equipment isolation system as claimed in claim 16 wherein said switch is movable between said first and second positions only where a plurality of operators have input authorised identification data to said operator identification device.

18. An equipment isolation system as claimed in claim 16 wherein said control system controls, and records details of, the operator(s) switch operation.

19. An equipment isolation system for remotely isolating an equipment item comprising:
an equipment isolation switch movable between a first position in which said equipment item is energised by an energy source and a second isolated position in which said equipment item is isolated from said energy source; and
an actuating device co-operable with the equipment isolation switch to move it between said first and second positions; and
an operator identification device for identifying an operator authorised to operate the equipment isolation switch,
wherein said actuating device is an operator identification means which also allows locking out and unlocking of the equipment isolation switch when communicated with the operator identification device.

20. An equipment isolation system as claimed in claim 19 wherein said operator identification means is a smart device.
